(19) United States
(12) Patent Application Publication
(10) Pub. No.: US 2026/0214100 A1
(43) Pub. Date: Jul. 23, 2026

(54) LCS RESOURCE AUTHORIZED LOCATION VERIFICATION SYSTEM

(71) Applicant: Dell Products L.P., Round Rock, TX (US)

(72) Inventors: Douglas Lang Farley, Round Rock, TX (US); Deepak Gaikwad, Natick, MA (US)

(21) Appl. No.: 19/026,863

(22) Filed: Jan. 17, 2025

(51) Int. Cl. H04L 9/40; G06F 9/50

(52) U.S. Cl. CPC H04L 63/107; G06F 9/5083; H04L 63/20

(57) ABSTRACT

An LCS resource authorized location verification system includes resource devices and a resource management system coupled to a BMS. The BMS receives an authenticated resource identity/location list authenticating the identity and location of the BMS and the resource devices. The BMS then provides an operating system with access to the authenticated resource identity/location list, and receives a request to provide an LCS using LCS resources including the BMS and the resource device(s). The BMS and operating system each validate the LCS provisioning instruction and confirm the LCS resources on the authenticated resource identity/location list and, in response, use the operating system to provide the LCS with access to the authenticated resource identity/location list. The LCS then confirms the LCS resources are on the authenticated resource identity/location list, provides an application, and uses the authenticated resource identity/location list to verify the authorized location of the LCS resources to the application.

### BACKGROUND

The present disclosure relates generally to information handling systems, and more particularly to verifying that resources in information handling systems used to provide a Logically Composed System (LCS) are located in an authorized location.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

While conventional information handling systems such as, for example, server devices and/or other computing devices known in the art have traditionally been provided with particular information handling systems components that configure it to satisfy one or more use cases, new computing paradigms provide for the allocation of resources from information handling systems and/or information handling system components for use in Logically Composed Systems (LCSs) that may be composed as needed to satisfy any computing intent/workload, and then decomposed such that those resources may be utilized in other LCSs. As such, users of the LCSs may be provided with LCSs that meet their current needs for any particular workload they require.

For example, an LCS may be provided using Bare Metal Servers (BMSs), with processing resources and memory resources in the BMS used to provide an Operating System (OS) for the LCS, and with different resources that may be included in the BMS and/or that are connected to the BMS via a network used to provide any desired functionality for the LCS. As such, LCSs may be composed of disaggregated, heterogeneous resources such as firmware, hardware, microvisors, and resource devices that may be used to perform operations for that LCS. The inventors of the present disclosure have recognized that there are many situations where it may be desirable to enable the authentication of the BMS and resource devices being used to provide an LCS, as well as the verification that the BMS and the resource devices that are being used to provide the LCS are in an authorized location.

Accordingly, it would be desirable to provide an LCS resource authorized location verification system that addresses the issues discussed above.

### SUMMARY

According to one embodiment, a Bare Metal Server (BMS) includes a processing system; and a memory system that is coupled to the processing system and that includes instructions that, when executed by the processing system, cause the processing system to provide a BMS engine that is configured to: receive an authenticated resource identity/location list that was generated by a resource management system and that authenticates a respective identity and location of each of a Bare Metal Server (BMS) that includes the processing system, and a plurality of resource devices; provide, in response to an operating system instruction from the resource management system, an operating system that has access to the authenticated resource identity/location list; receive, from the resource management system, an LCS provisioning instruction to provide an LCS using LCS resources that include the BMS and a subset of the plurality of resource devices, wherein the BMS engine and the operating system are each configured to: validate the LCS provisioning instruction and confirm the LCS resources are included on the authenticated resource identity/location list and, in response, use the operating system to provide the LCS that has access to the authenticated resource identity/location list and that is configured to: confirm the LCS resources are included on the authenticated resource identity/location list; provide an application; and verify, to the application using the authenticated resource identity/location list, the authorized location of each of the LCS resources.

### BRIEF DESCRIPTION OF THE DRAWINGS

FIG. 1 is a schematic view illustrating an embodiment of an Information Handling System (IHS).

FIG. 2 is a schematic view illustrating an embodiment of an LCS provisioning system.

FIG. 3 is a schematic view illustrating an embodiment of an LCS provisioning subsystem that may be included in the LCS provisioning system of FIG. 2.

FIG. 4 is a schematic view illustrating an embodiment of a resource system that may be included in the LCS provisioning subsystem of FIG. 3.

FIG. 5 is a schematic view illustrating an embodiment of the provisioning of an LCS using the LCS provisioning system of FIG. 2.

FIG. 6 is a schematic view illustrating an embodiment of the provisioning of an LCS using the LCS provisioning system of FIG. 2.

FIG. 7 is a flow chart illustrating an embodiment of a method for verifying that resources used for an LCS are provided in an authorized location.

FIG. 8 is a schematic view illustrating an embodiment of the LCS provisioning subsystem of FIG. 3 provided for use in the method of FIG. 7.

FIG. 9 is a schematic view illustrating an embodiment of the LCS provisioning subsystem of FIG. 8 operating during the method of FIG. 7.

FIG. 10 is a schematic view illustrating an embodiment of the LCS provisioning subsystem of FIG. 8 operating during the method of FIG. 7.

FIG. 11 is a schematic view illustrating an embodiment of the LCS provisioning subsystem of FIG. 8 operating during the method of FIG. 7.

FIG. 12A is a schematic view illustrating an embodiment of the LCS provisioning subsystem of FIG. 8 operating during the method of FIG. 7.

FIG. 12B is a schematic view illustrating an embodiment of the LCS provisioning subsystem of FIG. 8 operating during the method of FIG. 7.

FIG. 13A is a schematic view illustrating an embodiment of the LCS provisioning subsystem of FIG. 8 operating during the method of FIG. 7.

FIG. 13B is a schematic view illustrating an embodiment of the LCS provisioning subsystem of FIG. 8 operating during the method of FIG. 7.

FIG. 14 is a schematic view illustrating an embodiment of the LCS provisioning subsystem of FIG. 8 operating during the method of FIG. 7.

FIG. 15 is a schematic view illustrating an embodiment of the LCS provisioning subsystem of FIG. 8 operating during the method of FIG. 7.

FIG. 16A is a schematic view illustrating an embodiment of the LCS provisioning subsystem of FIG. 8 operating during the method of FIG. 7.

FIG. 16B is a schematic view illustrating an embodiment of the LCS provisioning subsystem of FIG. 8 operating during the method of FIG. 7.

FIG. 16C is a schematic view illustrating an embodiment of the LCS provisioning subsystem of FIG. 8 operating during the method of FIG. 7.

FIG. 17 is a schematic view illustrating an embodiment of the LCS provisioning subsystem of FIG. 8 operating during the method of FIG. 7.

FIG. 18 is a schematic view illustrating an embodiment of the LCS provisioning subsystem of FIG. 8 operating during the method of FIG. 7.

FIG. 19 is a schematic view illustrating an embodiment of the LCS provisioning subsystem of FIG. 8 operating during the method of FIG. 7.

FIG. 20 is a schematic view illustrating an embodiment of the LCS provisioning subsystem of FIG. 8 operating during the method of FIG. 7.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

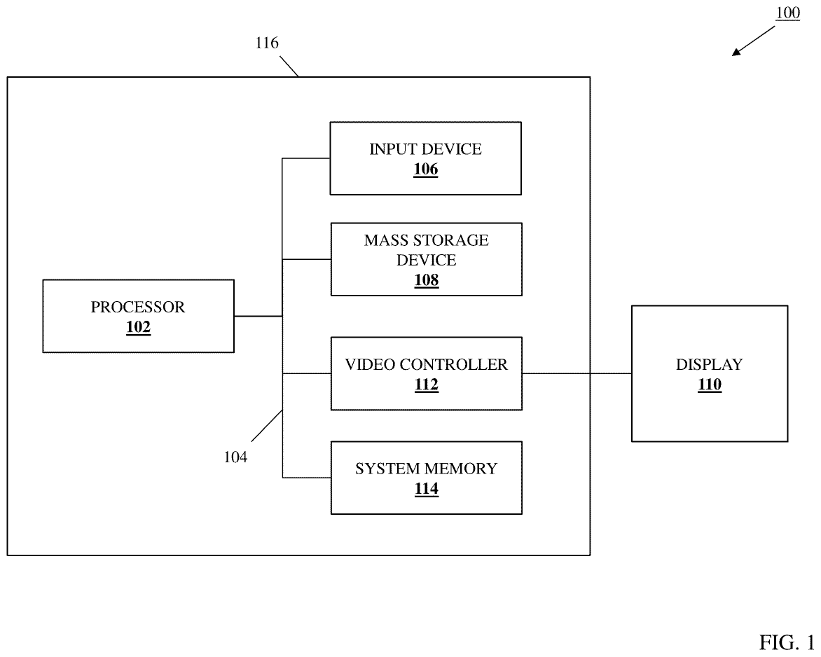

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

As discussed in further detail below, the Logically Composed System (LCS) resource authorized location verification systems and methods of the present disclosure may be utilized with LCSs, which one of skill in the art in possession of the present disclosure will recognize may be provided to users as part of an intent-based, as-a-Service delivery platform that enables multi-cloud computing while keeping the corresponding infrastructure that is utilized to do so “invisible” to the user in order to, for example, simplify the user/workload performance experience. As such, the LCSs discussed herein enable relatively rapid utilization of technology from a relatively broader resource pool, optimize the allocation of resources to workloads to provide improved scalability and efficiency, enable seamless introduction of new technologies and value-add services, and/or provide a variety of other benefits that would be apparent to one of skill in the art in possession of the present disclosure.

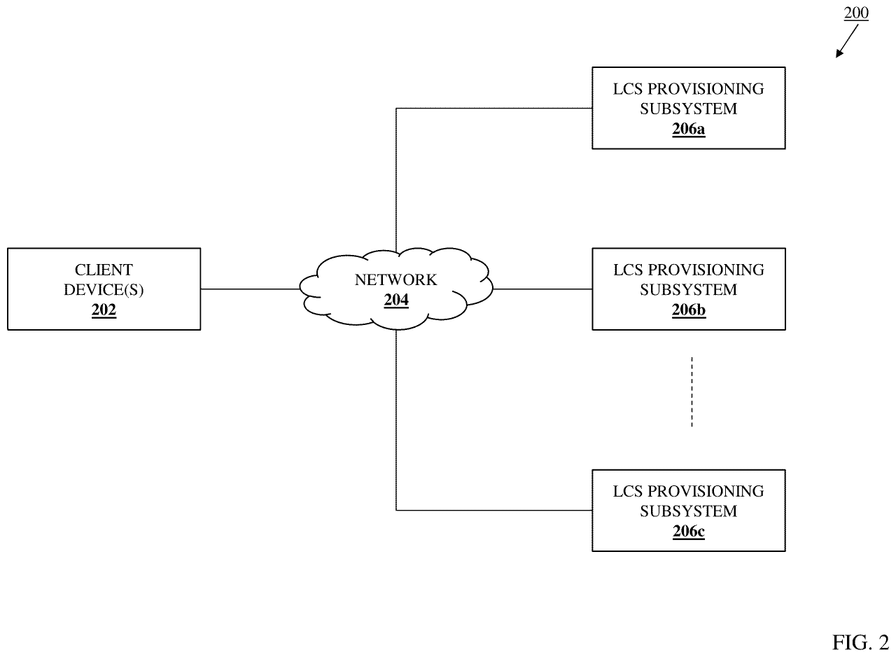

With reference to FIG. 2, an embodiment of a Logically Composed System (LCS) provisioning system 200 is illustrated that may be utilized with the LCS resource authorized location verification systems and methods of the present disclosure. In the illustrated embodiment, the LCS provisioning system 200 includes one or more client devices 202. In an embodiment, any or all of the client devices may be provided by the IHS 100 discussed above with reference to FIG. 1 and/or may include some or all of the components of the IHS 100, and in specific examples may be provided by desktop computing devices, laptop/notebook computing devices, tablet computing devices, mobile phones, and/or any other computing device known in the art. However, while illustrated and discussed as being provided by specific computing devices, one of skill in the art in possession of the present disclosure will recognize that the functionality of the client device(s) 202 discussed below may be provided by other computing devices that are configured to operate similarly as the client device(s) 202 discussed below, and that one of skill in the art in possession of the present disclosure would recognize as utilizing the LCSs described herein. As illustrated, the client device(s) 202 may be coupled to a network 204 that may be provided by a Local Area Network (LAN), the Internet, combinations thereof, and/or any of network that would be apparent to one of skill in the art in possession of the present disclosure.

As also illustrated in FIG. 2, a plurality of LCS provisioning subsystems 206a, 206b, and up to 206c are coupled to the network 204 such that any or all of those LCS provisioning subsystems 206a-206c may provide LCSs to the client device(s) 202 as discussed in further detail below. In an embodiment, any or all of the LCS provisioning subsystems 206a-206c may include one or more of the IHS 100 discussed above with reference to FIG. 1 and/or may include some or all of the components of the IHS 100. For example, in some of the specific examples provided below, each of the LCS provisioning subsystems 206a-206c may be provided by a respective datacenter or other computing device/computing component location (e.g., a respective one of the “clouds” that enables the “multi-cloud” computing discussed above) in which the components of that LCS provisioning subsystem are included. However, while a specific configuration of the LCS provisioning system 200 (e.g., including multiple LCS provisioning subsystems 206a-206c) is illustrated and described, one of skill in the art in possession of the present disclosure will recognize that other configurations of the LCS provisioning system 200 (e.g., a single LCS provisioning subsystem, LCS provisioning subsystems that span multiple datacenters/computing device/computing component locations, etc.) will fall within the scope of the present disclosure as well.

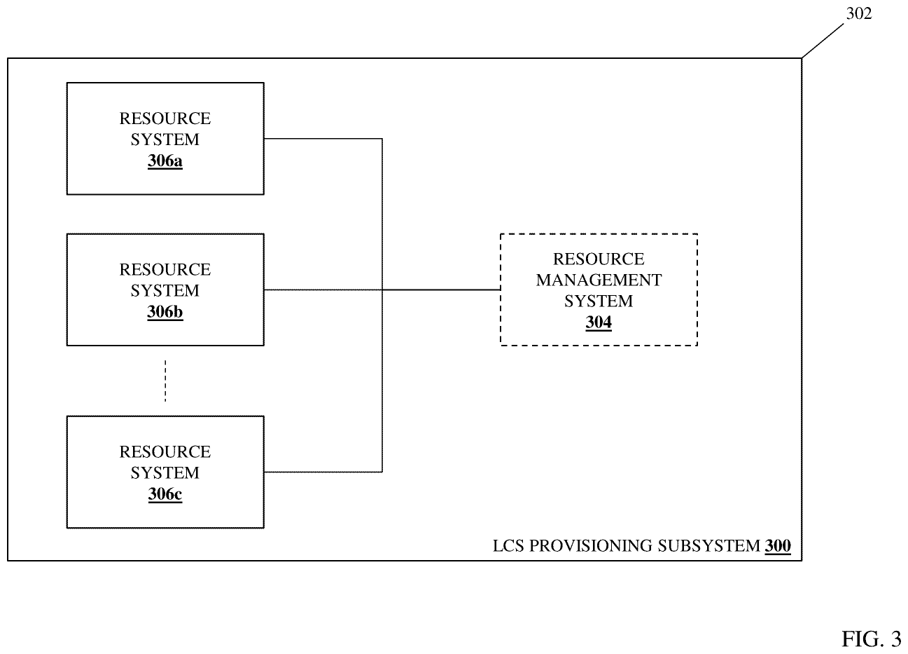

With reference to FIG. 3, an embodiment of an LCS provisioning subsystem 300 is illustrated that may provide any of the LCS provisioning subsystems 206a-206c discussed above with reference to FIG. 2. As such, the LCS provisioning subsystem 300 may include one or more of the IHS 100 discussed above with reference to FIG. 1 and/or may include some or all of the components of the IHS 100, and in the specific examples provided below may be provided by a datacenter or other computing device/computing component location in which the components of the LCS provisioning subsystem 300 are included. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

In the illustrated embodiment, the LCS provisioning subsystem 300 is provided in a datacenter 302, and includes a resource management system 304 coupled to a plurality of resource systems 306a, 306b, and up to 306c. In an embodiment, any of the resource management system 304 and the resource systems 306a-306c may be provided by the IHS 100 discussed above with reference to FIG. 1 and/or may include some or all of the components of the IHS 100. In the specific embodiments provided below, each of the resource management system 304 and the resource systems 306a-306c may include a System Control Processor (SCP) device that may be conceptualized as an “enhanced” SmartNIC device that may be configured to perform functionality that is not available in conventional SmartNIC devices such as, for example, the resource management functionality, LCS provisioning functionality, and/or other SCP functionality described herein.

In an embodiment, any of the resource systems 306a-306c may include any of the resources described below coupled to an SCP device that is configured to facilitate management of those resources by the resource management system 304. Furthermore, the SCP device included in the resource management system 304 may provide an SCP Manager (SCPM) subsystem that is configured to manage the SCP devices in the resource systems 306a-306c, and that performs the functionality of the resource management system 304 described below. In some examples, the resource management system 304 may be provided by a “stand-alone” system (e.g., that is provided in a separate chassis from each of the resource systems 306a-306c), and the SCPM subsystem discussed below may be provided by a dedicated SCP device, processing/memory resources, and/or other components in that resource management system 304. However, in other embodiments, the resource management system 304 may be provided by one of the resource systems 306a-306c (e.g., it may be provided in a chassis of one of the resource systems 306a-306c), and the SCPM subsystem may be provided by an SCP device, processing/memory resources, and/or any other components om that resource system.

As such, the resource management system 304 is illustrated with dashed lines in FIG. 3 to indicate that it may be a stand-alone system in some embodiments, or may be provided by one of the resource systems 306a-306c in other embodiments. Furthermore, one of skill in the art in possession of the present disclosure will appreciate how SCP devices in the resource systems 306a-306c may operate to “elect” or otherwise select one or more of those SCP devices to operate as the SCPM subsystem that provides the resource management system 304 described below. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

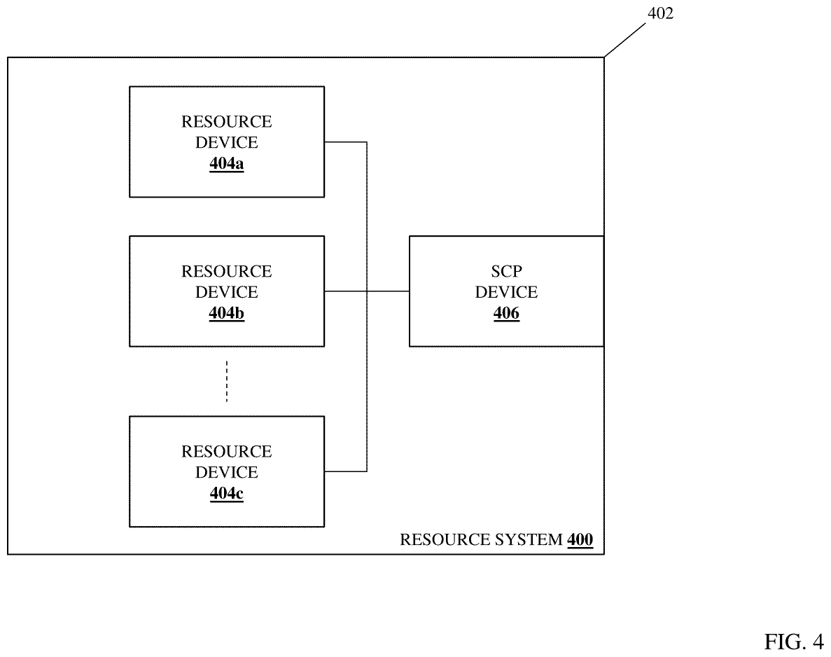

With reference to FIG. 4, an embodiment of a resource system 400 is illustrated that may provide any or all of the resource systems 306a-306c discussed above with reference to FIG. 3. In an embodiment, the resource system 400 may be provided by the IHS 100 discussed above with reference to FIG. 1 and/or may include some or all of the components of the IHS 100. In the illustrated embodiment, the resource system 400 includes a chassis 402 that houses the components of the resource system 400, only some of which are illustrated and discussed below. In the illustrated embodiment, the chassis 402 houses an SCP device 406. In an embodiment, the SCP device 406 may include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide an SCP engine that is configured to perform the functionality of the SCP engines and/or SCP devices discussed below. Furthermore, the SCP device 406 may also include any of a variety of SCP components (e.g., hardware/software) that are configured to enable any of the SCP functionality described below.

In the illustrated embodiment, the chassis 402 also houses a plurality of resource devices 404a, 404b, and up to 404c, each of which is coupled to the SCP device 406. For example, the resource devices 404a-404c may include processing systems (e.g., first type processing systems such as those available from INTEL® Corporation of Santa Clara, California, United States, second type processing systems such as those available from ADVANCED MICRO DEVICES (AMD)® Inc. of Santa Clara, California, United States, Advanced Reduced Instruction Set Computer (RISC) Machine (ARM) devices, Graphics Processing Unit (GPU) devices, Tensor Processing Unit (TPU) devices, Field Programmable Gate Array (FPGA) devices, accelerator devices, etc.); memory systems (e.g., Persistence MEMory (PMEM) devices (e.g., solid state byte-addressable memory devices that reside on a memory bus), etc.); storage devices (e.g., Non-Volatile Memory express over Fabric (NVMe-oF) storage devices, Just a Bunch Of Flash (JBOF) devices, etc.); networking devices (e.g., Network Interface Controller (NIC) devices, etc.); and/or any other devices that one of skill in the art in possession of the present disclosure would recognize as enabling the functionality described as being enabled by the resource devices 404a-404c discussed below. As such, the resource devices 404a-404c in the resource systems 306a-306c/400 may be considered a “pool” of resources that are available to the resource management system 304 for use in composing LCSs.

To provide a specific example, the SCP devices described herein may operate to provide a Root-of-Trust (RoT) for their corresponding resource devices/systems, to provide an intent management engine for managing the workload intents discussed below, to perform telemetry generation and/or reporting operations for their corresponding resource devices/systems, to perform identity operations for their corresponding resource devices/systems, provide an image boot engine (e.g., an operating system image boot engine) for LCSs composed using a processing system/memory system controlled by that SCP device, and/or perform any other operations that one of skill in the art in possession of the present disclosure would recognize as providing the functionality described below. Further, as discussed below, the SCP devices describe herein may include Software-Defined Storage (SDS) subsystems, inference subsystems, data protection subsystems, Software-Defined Networking (SDN) subsystems, trust subsystems, data management subsystems, compression subsystems, encryption subsystems, and/or any other hardware/software described herein that may be allocated to an LCS that is composed using the resource devices/systems controlled by that SCP device. However, while an SCP device is illustrated and described as performing the functionality discussed below, one of skill in the art in possession of the present disclosure will appreciated that functionality described herein may be enabled on other devices while remaining within the scope of the present disclosure as well.

Thus, the resource system 400 may include the chassis 402 including the SCP device 406 connected to any combinations of resource devices. To provide a specific embodiment, the resource system 400 may provide a “Bare Metal Server” that one of skill in the art in possession of the present disclosure will recognize may be a physical server system that provides dedicated server hosting to a single tenant, and thus may include the chassis 402 housing a processing system and a memory system, the SCP device 406, as well as any other resource devices that would be apparent to one of skill in the art in possession of the present disclosure. However, in other specific embodiments, the resource system 400 may include the chassis 402 housing the SCP device 406 coupled to particular resource devices 404a-404c. For example, the chassis 402 of the resource system 400 may house a plurality of processing systems (i.e., the resource devices 404a-404c) coupled to the SCP device 406. In another example, the chassis 402 of the resource system 400 may house a plurality of memory systems (i.e., the resource devices 404a-404c) coupled to the SCP device 406. In another example, the chassis 402 of the resource system 400 may house a plurality of storage devices (i.e., the resource devices 404a-404c) coupled to the SCP device 406. In another example, the chassis 402 of the resource system 400 may house a plurality of networking devices (i.e., the resource devices 404a-404c) coupled to the SCP device 406. However, one of skill in the art in possession of the present disclosure will appreciate that the chassis 402 of the resource system 400 housing a combination of any of the resource devices discussed above will fall within the scope of the present disclosure as well.

As discussed in further detail below, the SCP device 406 in the resource system 400 will operate with the resource management system 304 (e.g., an SCPM subsystem) to allocate any of its resources devices 404a-404c for use in a providing an LCS. Furthermore, the SCP device 406 in the resource system 400 may also operate to allocate SCP hardware and/or perform functionality, which may not be available in a resource device that it has allocated for use in providing an LCS, in order to provide any of a variety of functionality for the LCS. For example, the SCP engine and/or other hardware/software in the SCP device 406 may be configured to perform encryption functionality, compression functionality, and/or other storage functionality known in the art, and thus if that SCP device 406 allocates storage device(s) (which may be included in the resource devices it controls) for use in a providing an LCS, that SCP device 406 may also utilize its own SCP hardware and/or software to perform that encryption functionality, compression functionality, and/or other storage functionality as needed for the LCS as well. However, while particular SCP-enabled storage functionality is described herein, one of skill in the art in possession of the present disclosure will appreciate how the SCP devices 406 described herein may allocate SCP hardware and/or perform other enhanced functionality for an LCS provided via allocation of its resource devices 404a-404c while remaining within the scope of the present disclosure as well.

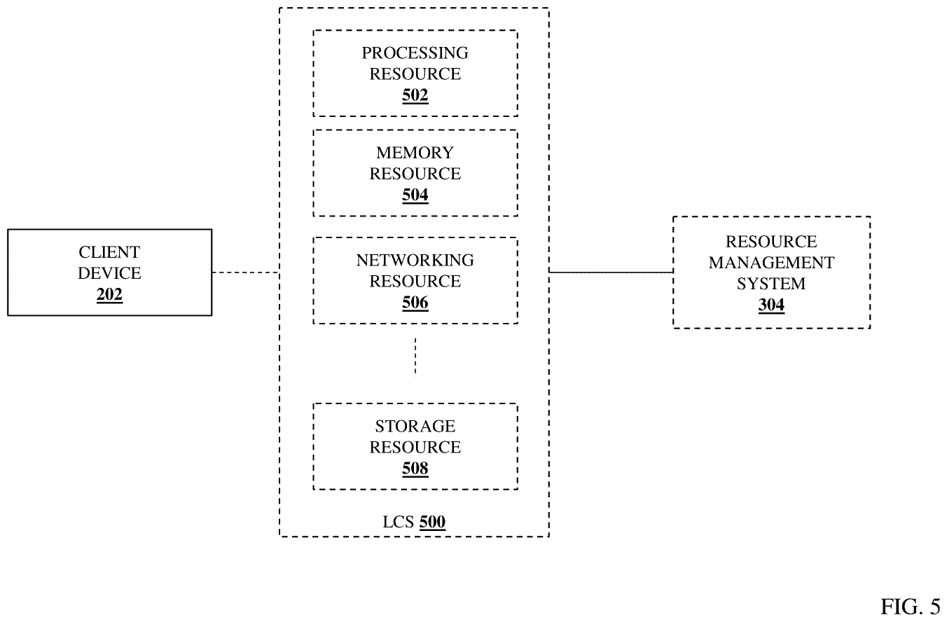

With reference to FIG. 5, an example of the provisioning of an LCS 500 to one of the client device(s) 202 is illustrated. For example, the LCS provisioning system 200 may allow a user of the client device 202 to express a “workload intent” that describes the general requirements of a workload that user would like to perform (e.g., “I need an LCS with 10 gigahertz (Ghz) of processing power and 8 gigabytes (GB) of memory capacity for an application requiring 20 terabytes (TB) of high-performance protected-object-storage for use with a hospital-compliant network”, or “I need an LCS for a machine-learning environment requiring Tensorflow processing with 3 TBs of Accelerator PMEM memory capacity”). As will be appreciated by one of skill in the art in possession of the present disclosure, the workload intent discussed above may be provided to one of the LCS provisioning subsystems 206a-206c, and may be satisfied using resource systems that are included within that LCS provisioning subsystem, or satisfied using resource systems that are included across the different LCS provisioning subsystems 206a-206c.

As such, the resource management system 304 in the LCS provisioning subsystem that received the workload intent may operate to compose the LCS 500 using resource devices 404a-404c in the resource systems 306a-306c/400 in that LCS provisioning subsystem, and/or resource devices 404a-404c in the resource systems 306a-306c/400 in any of the other LCS provisioning subsystems. FIG. 5 illustrates the LCS 500 including a processing resource 502 allocated from one or more processing systems provided by one or more of the resource devices 404a-404c in one or more of the resource systems 306a-306c/400 in one or more of the LCS provisioning subsystems 206a-206c, a memory resource 504 allocated from one or more memory systems provided by one or more of the resource devices 404a-404c in one or more of the resource systems 306a-306c/400 in one or more of the LCS provisioning subsystems 206a-206c, a networking resource 506 allocated from one or more networking devices provided by one or more of the resource devices 404a-404c in one or more of the resource systems 306a-306c/400 in one or more of the LCS provisioning subsystems 206a-206c, and/or a storage resource 508 allocated from one or more storage devices provided by one or more of the resource devices 404a-404c in one or more of the resource systems 306a-306c/400 in one or more of the LCS provisioning subsystems 206a-206c.

Furthermore, as will be appreciated by one of skill in the art in possession of the present disclosure, any of the processing resource 502, memory resource 504, networking resource 506, and the storage resource 508 may be provided from a portion of a processing system (e.g., a core in a processor, a time-slice of processing cycles of a processor, etc.), a portion of a memory system (e.g., a subset of memory capacity in a memory device), a portion of a storage device (e.g., a subset of storage capacity in a storage device), and/or a portion of a networking device (e.g., a portion of the bandwidth of a networking device). Further still, as discussed above, the SCP device(s) 406 in the resource systems 306a-306c/400 that allocate any of the resource devices 404a-404c that provide the processing resource 502, memory resource 504, networking resource 506, and the storage resource 508 in the LCS 500 may also allocate their SCP hardware and/or perform enhanced functionality (e.g., the enhanced storage functionality in the specific examples provided above) for any of those resources that may otherwise not be available in the processing system, memory system, storage device, or networking device allocated to provide those resources in the LCS 500.

With the LCS 500 composed using the processing resources 502, the memory resources 504, the networking resources 506, and the storage resources 508, the resource management system 304 may provide the client device 202 resource communication information such as, for example, Internet Protocol (IP) addresses of each of the systems/devices that provide the resources that make up the LCS 500, in order to allow the client device 202 to communicate with those systems/devices in order to utilize the resources that make up the LCS 500. As will be appreciated by one of skill in the art in possession of the present disclosure, the resource communication information may include any information that allows the client device 202 to present the LCS 500 to a user in a manner that makes the LCS 500 appear the same as an integrated physical system having the same resources as the LCS 500.

Thus, continuing with the specific example above in which the user provided the workload intent defining an LCS with a 10 Ghz of processing power and 8 GB of memory capacity for an application with 20 TB of high-performance protected object storage for use with a hospital-compliant network, the processing resources 502 in the LCS 500 may be configured to utilize 10 Ghz of processing power from processing systems provided by resource device(s) in the resource system(s), the memory resources 504 in the LCS 500 may be configured to utilize 8 GB of memory capacity from memory systems provided by resource device(s) in the resource system(s), the storage resources 508 in the LCS 500 may be configured to utilize 20 TB of storage capacity from high-performance protected-object-storage storage device(s) provided by resource device(s) in the resource system(s), and the networking resources 506 in the LCS 500 may be configured to utilize hospital-compliant networking device(s) provided by resource device(s) in the resource system(s).

Similarly, continuing with the specific example above in which the user provided the workload intent defining an LCS for a machine-learning environment for Tensorflow processing with 3 TBs of Accelerator PMEM memory capacity, the processing resources 502 in the LCS 500 may be configured to utilize TPU processing systems provided by resource device(s) in the resource system(s), and the memory resources 504 in the LCS 500 may be configured to utilize 3 TB of accelerator PMEM memory capacity from processing systems/memory systems provided by resource device(s) in the resource system(s), while any networking/storage functionality may be provided for the networking resources 506 and storage resources 508, if needed.

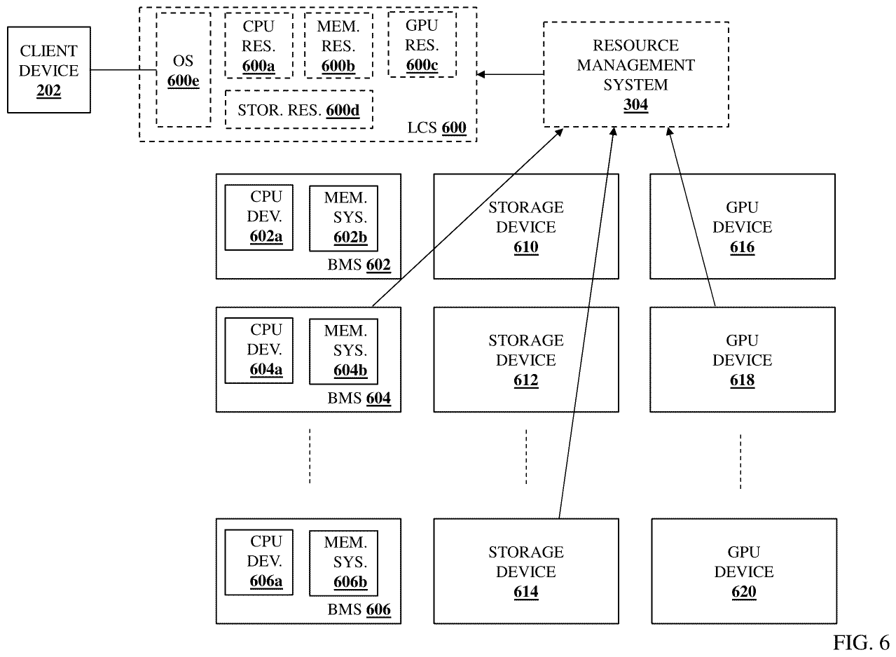

With reference to FIG. 6, another example of the provisioning of an LCS 600 to one of the client device(s) 202 is illustrated. As will be appreciated by one of skill in the art in possession of the present disclosure, many of the LCSs provided by the LCS provisioning system 200 will utilize a “compute” resource (e.g., provided by a processing resource such as an x86 processor, an AMD processor, an ARM processor, and/or other processing systems known in the art, along with a memory system that includes instructions that, when executed by the processing system, cause the processing system to perform any of a variety of compute operations known in the art), and in many situations those compute resources may be allocated from a Bare Metal Server (BMS) and presented to a client device 202 user along with storage resources, networking resources, other processing resources (e.g., GPU resources), and/or any other resources that would be apparent to one of skill in the art in possession of the present disclosure.

As such, in the illustrated embodiment, the resource systems 306a-306c available to the resource management system 304 include a Bare Metal Server (BMS) 602 having a Central Processing Unit (CPU) device 602a and a memory system 602b, a BMS 604 having a CPU device 604a and a memory system 604b, and up to a BMS 606 having a CPU device 606a and a memory system 606b. Furthermore, one or more of the resource systems 306a-306c includes resource devices 404a-404c provided by a storage device 610, a storage device 612, and up to a storage device 614. Further still, one or more of the resource systems 306a-306c includes resource devices 404a-404c provided by a Graphics Processing Unit (GPU) device 616, a GPU device 618, and up to a GPU device 620.

FIG. 6 illustrates how the resource management system 304 may compose the LCS 600 using the BMS 604 to provide the LCS 600 with CPU resources 600a that utilize the CPU device 604a in the BMS 604, and memory resources 600b that utilize the memory system 604b in the BMS 604. Furthermore, the resource management system 304 may compose the LCS 600 using the storage device 614 to provide the LCS 600 with storage resources 600d, and using the GPU device 318 to provide the LCS 600 with GPU resources 600c. As illustrated in the specific example in FIG. 6, the CPU device 604a and the memory system 604b in the BMS 604 may be configured to provide an operating system 600e that is presented to the client device 202 as being provided by the CPU resources 600a and the memory resources 600b in the LCS 600, with operating system 600e utilizing the GPU device 618 to provide the GPU resources 600c in the LCS 600, and utilizing the storage device 614 to provide the storage resources 600d in the LCS 600. The user of the client device 202 may then provide any application(s) on the operating system 600e provided by the CPU resources 600a/CPU device 604a and the memory resources 600b/memory system 604b in the LCS 600/BMS 604, with the application(s) operating using the CPU resources 600a/CPU device 604a, the memory resources 600b/memory system 604b, the GPU resources 600c/GPU device 618, and the storage resources 600d/storage device 614.

Furthermore, as discussed above, the SCP device(s) 406 in the resource systems 306a-306c/400 that allocates any of the CPU device 604a and memory system 604b in the BMS 604 that provide the CPU resource 600a and memory resource 600b, the GPU device 618 that provides the GPU resource 600c, and the storage device 614 that provides storage resource 600d, may also allocate SCP hardware and/or perform enhanced functionality (e.g., the enhanced storage functionality in the specific examples provided above) for any of those resources that may otherwise not be available in the CPU device 604a, memory system 604b, storage device 614, or GPU device 618 allocated to provide those resources in the LCS 500.

However, while simplified examples are described above, one of skill in the art in possession of the present disclosure will appreciate how multiple devices/systems (e.g., multiple CPUs, memory systems, storage devices, and/or GPU devices) may be utilized to provide an LCS. Furthermore, any of the resources utilized to provide an LCS (e.g., the CPU resources, memory resources, storage resources, and/or GPU resources discussed above) need not be restricted to the same device/system, and instead may be provided by different devices/systems over time (e.g., the GPU resources 600c may be provided by the GPU device 618 during a first time period, by the GPU device 616 during a second time period, and so on) while remaining within the scope of the present disclosure as well. Further still, while the discussions above imply the allocation of physical hardware to provide LCSs, one of skill in the art in possession of the present disclosure will recognize that the LCSs described herein may be composed similarly as discussed herein from virtual resources. For example, the resource management system 304 may be configured to allocate a portion of a logical volume provided in a Redundant Array of Independent Disk (RAID) system to an LCS, allocate a portion/time-slice of GPU processing performed by a GPU device to an LCS, and/or perform any other virtual resource allocation that would be apparent to one of skill in the art in possession of the present disclosure in order to compose an LCS.

Similarly as discussed above, with the LCS 600 composed using the CPU resources 600a, the memory resources 600b, the GPU resources 600c, and the storage resources 600d, the resource management system 304 may provide the client device 202 resource communication information such as, for example, Internet Protocol (IP) addresses of each of the systems/devices that provide the resources that make up the LCS 600, in order to allow the client device 202 to communicate with those systems/devices in order to utilize the resources that make up the LCS 600. As will be appreciated by one of skill in the art in possession of the present disclosure, the resource communication information allows the client device 202 to present the LCS 600 to a user in a manner that makes the LCS 600 appear the same as an integrated physical system having the same resources as the LCS 600.

As will be appreciated by one of skill in the art in possession of the present disclosure, the LCS provisioning system 200 discussed above solves issues present in conventional Information Technology (IT) infrastructure systems that utilize “purpose-built” devices (server devices, storage devices, etc.) in the performance of workloads and that often result in resources in those devices being underutilized. This is accomplished, at least in part, by having the resource management system(s) 304 “build” LCSs that satisfy the needs of workloads when they are deployed. As such, a user of a workload need simply define the needs of that workload via a “manifest” expressing the workload intent of the workload, and resource management system 304 may then compose an LCS by allocating resources that define that LCS and that satisfy the requirements expressed in its workload intent, and present that LCS to the user such that the user interacts with those resources in same manner as they would physical system at their location having those same resources.

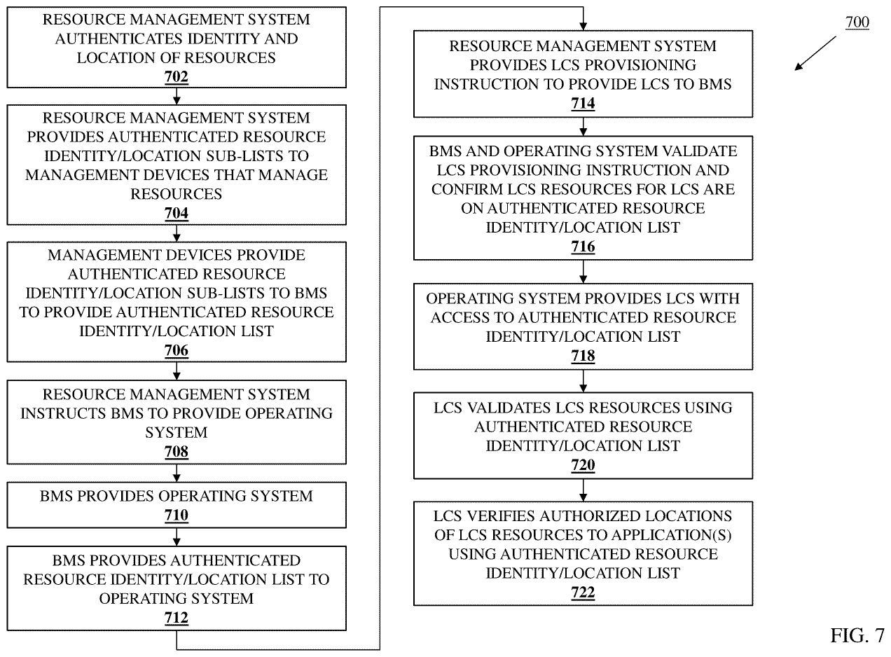

Referring now to FIG. 7, an embodiment of a method 700 for verifying that resources used for an Logically Composed System (LCS) are provided in an authorized location is illustrated. As discussed below, the systems and methods of the present disclosure provide for verification that LCS resources being used by an LCS are provided in an authorized location. For example, the LCS resource authorized location verification system of the present disclosure may include resource devices and a resource management system coupled to a BMS. The BMS receives an authenticated resource identity/location list authenticating the identity and location of the BMS and the resource devices. The BMS then provides an operating system with access to the authenticated resource identity/location list, and receives a request to provide an LCS using LCS resources including the BMS and the resource device(s). The BMS and operating system each validate the LCS provisioning instruction and confirm the LCS resources on the authenticated resource identity/location list and, in response, use the operating system to provide the LCS with access to the authenticated resource identity/location list. The LCS then confirms the LCS resources are on the authenticated resource identity/location list, provides an application, and uses the authenticated resource identity/location list to verify the authorized location of the LCS resources to the application. As such, a user of an application may ensure that their application is being provided by an LCS that uses LCS resources in locations they authorize.

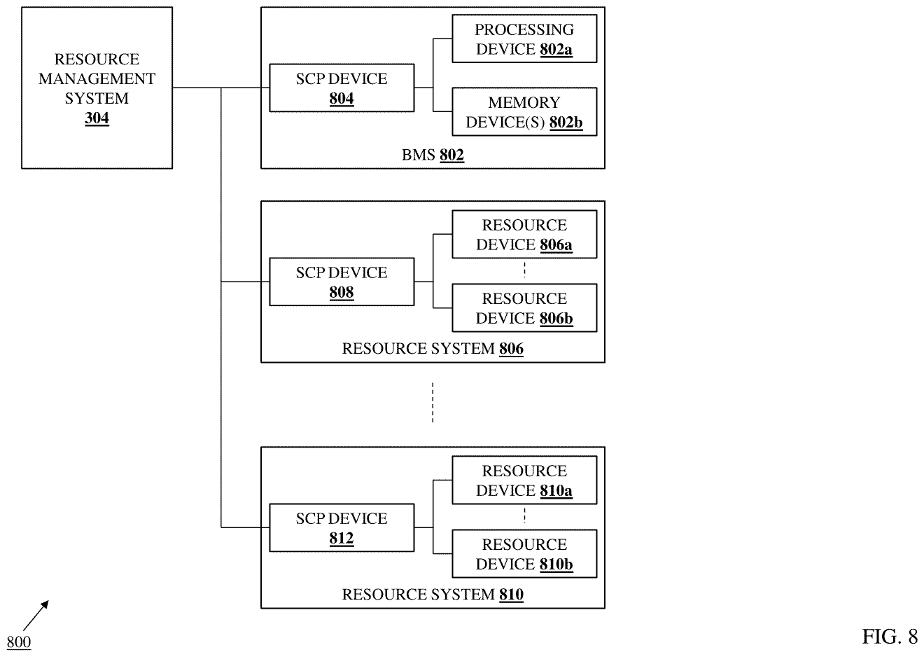

With reference to FIG. 8, an embodiment of an LCS provisioning subsystem 800 is illustrated that may be provided by the LCS provisioning subsystem 300 discussed above with reference to FIG. 3, with any of the resource systems 306a-306c provided by the resource system 400 discussed above with reference to FIG. 4. In the illustrated examples, the LCS provisioning subsystem 800 includes the resource management system 304 discussed above with reference to FIG. 3 coupled to a plurality of resource systems. As illustrated, one of the resource systems coupled to the resource management system 304 is provided by a Bare Metal Server (BMS) 802 that is coupled to the resource management system 304, and may be provided by any of the BMSs 602-606 discussed above with reference to FIG. 6. As discussed above, the BMS 802 may include a plurality of resource devices, only some of which are illustrated and described below. For example, the resource devices in the BMS 802 in the examples below include a processing device 802a coupled to one or more memory devices 802b, but one of skill in the art in possession of the present disclosure will appreciate how the BMS 802 may include any of a variety of resource devices while remaining within the scope of the present disclosure.

In the examples below, the BMS 802 also includes a management device that is illustrated and described as being provided by an SCP device 804 that is coupled to the resource management system 304, the processing device 802a, and the memory device(s) 802b. In some embodiments, the SCP device 804 may be provided by the SCP device 406 in the resource system 400 discussed above with reference to FIG. 4. In other embodiments, the SCP device 804 may be provided by a Baseboard Management Controller (BMC) device such as, for example, an integrated DELL® Remote Access Controller (iDRAC) device provided in BMSs available from DELL® Inc. of Round Rock, Texas, United States.

However, while two specific examples have been provided, the SCP device 804 may be provided by a variety of devices that would be apparent to one of skill in the art in possession of the present disclosure. As will be appreciated by one of skill in the art in possession of the present disclosure, the resource management system 304 and the SCP device 804 provides a secure control plane for providing an LCS using the BMS 802 and authenticated resource devices in verifiable locations, while also enabling that LCS to authenticate the resource devices used to provide it and verify the location of those resource devices. Furthermore, the processing device in the SCP device 804 and the processing device 802a may provide a processing system in the BMS 802, while memory device(s) in the SCP device and the memory device(s) 802b may provide a memory system in the BMS 802 that includes instructions that, when executed by the processing system, cause the processing system to perform the functionality of the BMS 802 discussed below. However, while a specific example of a BMS 802 has been illustrated and described and is used in the specific examples provided below, one of skill in the art in possession of the present disclosure will appreciate how BMSs utilized in the LCS resource authorized location verification system of the present disclosure may include a variety of components and/or component configurations while remaining within the scope of the present disclosure as well.

In the illustrated examples, the LCS provisioning subsystem 800 also includes a plurality of resource systems 806 and up to 808, each of which may be provided by the resource systems 306a-306c and 400 discussed above with reference to FIGS. 3 and 4. As such, the resource system 806 may include a plurality of resource devices 806a and up to 806b that may be provided by any of the resource devices discussed above. In the examples below, the resource system 806 also includes a management device that is illustrated and described as being provided by an SCP device 808 that is coupled to the resource management system 304 and the resource devices 806a-806b. In some embodiments, the SCP device 808 may be provided by the SCP device 406 in the resource system 400 discussed above with reference to FIG. 4. In other embodiments, the SCP device 808 may be provided by a BMC device such as, for example, an integrated iDRAC device available from DELL® Inc. of Round Rock, Texas, United States.

Similarly, the resource system 810 may include a plurality of resource devices 810a and up to 810b that may be provided by any of the resource devices discussed above. In the examples below, the resource system 810 also includes a management device that is illustrated and described as being provided by an SCP device 812 that is coupled to the resource management system 304 and the resource devices 810a-810b. In some embodiments, the SCP device 812 may be provided by the SCP device 406 in the resource system 400 discussed above with reference to FIG. 4. In other embodiments, the SCP device 812 may be provided by a BMC device such as, for example, an integrated iDRAC device available from DELL® Inc. of Round Rock, Texas, United States. However, while a specific LCS provisioning system 800 has been described, one of skill in the art in possession of the present disclosure will appreciate how the LCS resource authorized location verification system of the present disclosure may utilize a variety of LCS provisioning systems while remaining within the scope of the present disclosure as well.

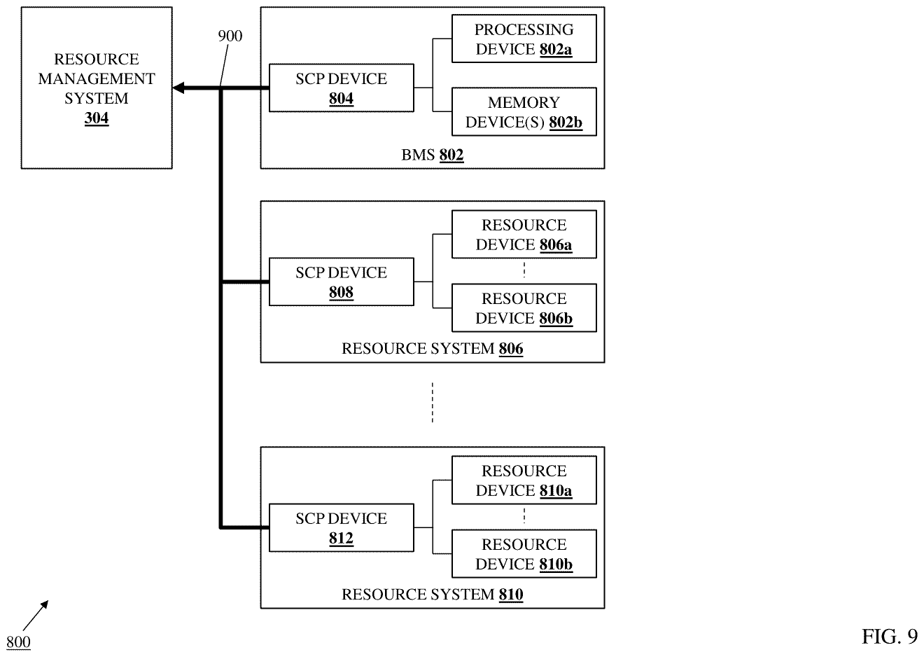

The method 700 begins at block 702 where a resource management system authenticates an identity and location of resources. With reference to FIG. 9, in an embodiment of block 702, each of the SCP devices 804, 808, and 812 may perform resource device inventory identification operations 900 that include identifying its inventory of resource devices to the resource management system 304. As such, the resource device inventory identification operations 900 by the SCP device 804 may include the SCP device 804 generating an inventory identifying the processing device 802a, the memory device(s) 802b, and any other resource devices in the BMS 802, and providing that inventory to the resource management system 304. Similarly, the resource device inventory identification operations 900 by the SCP device 808 may include the SCP device 808 generating an inventory identifying the resource devices 806a-806b in the resource system 806, and providing that inventory to the resource management system 304. Similarly, the resource device inventory identification operations 900 by the SCP device 812 may include the SCP device 8112 generating an inventory identifying the resource devices 810a-810b in the resource system 810, and providing that inventory to the resource management system 304.

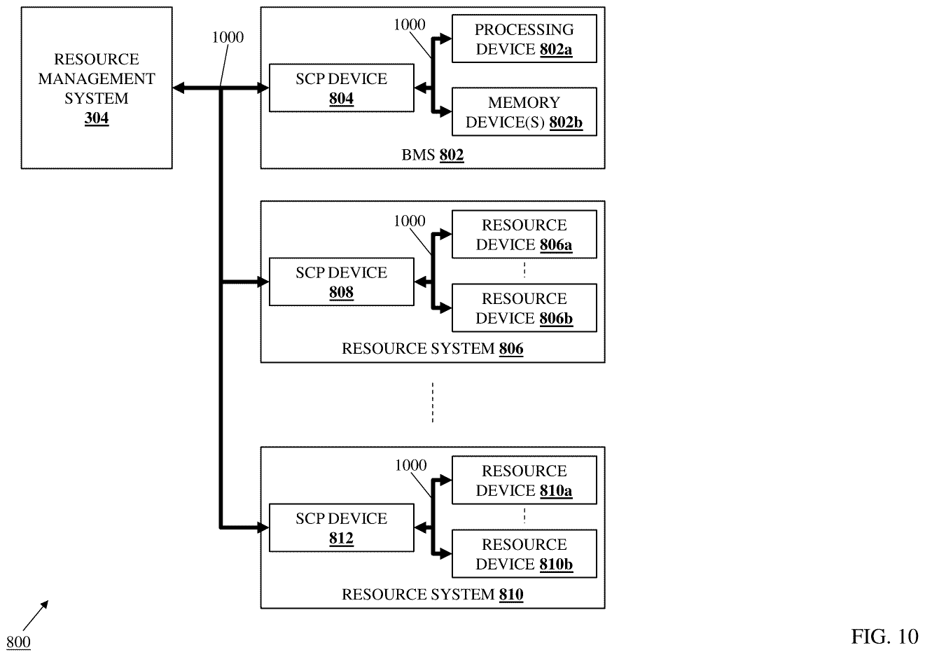

With reference to FIG. 10, in response to receiving the inventories from the SCP devices 804, 808, and 812, the resource management system 304 may perform resource identity/location authentication operations 1000 that may include authenticating the resource devices identified in each inventory and determining a location of those resource devices. As such, the resource identity/location authentication operations 1000 by the resource management system 304 may include the resource management system 304 authenticating each of the processing device 802a, the memory device(s) 802b, and any other resource devices in the BMS 802 (e.g., cryptographically authenticating the processing device 802a, the memory device(s) 802b, and any other resource devices in the BMS 802 using a certificate(s) provided by a manufacturer of the BMS 802 and/or using other authentication techniques that would be apparent to one of skill in the art in possession of the present disclosure), and identifying a location of the BMS 802 using any of a variety of location information that is associated with the BMS 802 and accessible to the resource management system 304 (e.g., location information provided by the networking connections provided by switch devices, router devices, etc. coupling the resource management system 304 to the BMS 802).

Similarly, the resource identity/location authentication operations 1000 by the resource management system 304 may include the resource management system 304 authenticating each of the resource devices 806a-806b in the resource system 806 (e.g., cryptographically authenticating the resource devices 806a-806b in the resource system 806 using a certificate(s) provided by a manufacturer of the resource system 806 and/or using other authentication techniques that would be apparent to one of skill in the art in possession of the present disclosure), and identifying a location of the resource system 806 using any of a variety of location information that is associated with the resource system 806 and accessible to the resource management system 304 (e.g., location information provided by the networking connections provided by switch devices, router devices, etc. coupling the resource management system 304 to the resource system 806).

Similarly, the resource identity/location authentication operations 1000 by the resource management system 304 may include the resource management system 304 authenticating each of the resource devices 810a-810b in the resource system 810 (e.g., cryptographically authenticating the resource devices 810a-810b in the resource system 810 using a certificate(s) provided by a manufacturer of the resource system 810 and/or using other authentication techniques that would be apparent to one of skill in the art in possession of the present disclosure), and identifying a location of the resource system 810 using any of a variety of location information that is associated with the resource system 810 and accessible to the resource management system 304 (e.g., location information provided by the networking connections provided by switch devices, router devices, etc. coupling the resource management system 304 to the resource system 810).

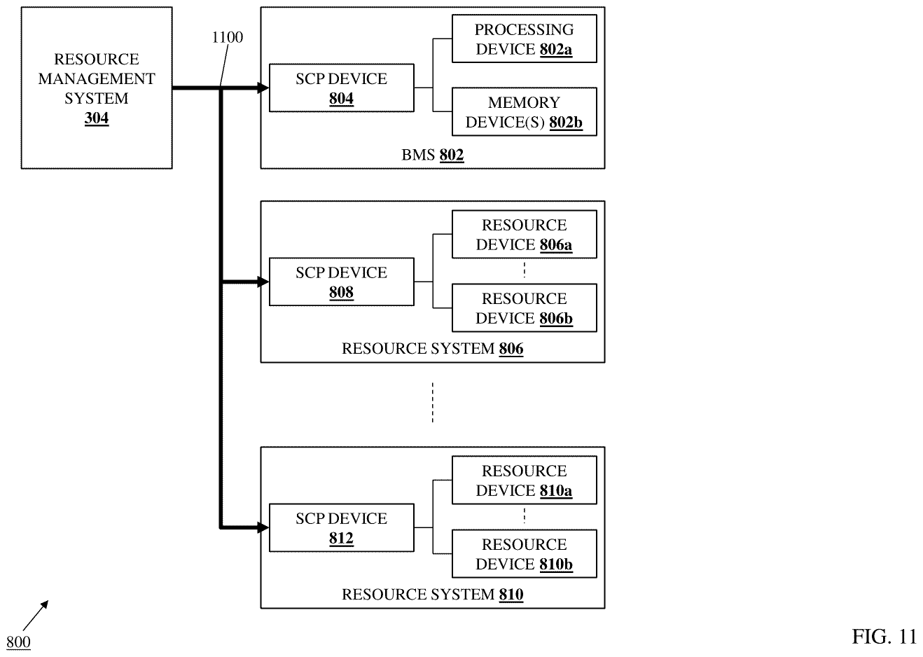

The method 700 then proceeds to block 704 where the resource management system provides authenticated resource identity/location sub-lists to management devices that manage the resources. With reference to FIG. 11, in an embodiment of block 704, the resource management system 304 may perform authenticated resource identity/location sub-list provisioning operations 1100 that include generating a respective authenticated resource identity/location sub-list for the resource devices included in each of the BMS 802 and the resource systems 806 and 810, and providing those authenticated resource identity/location sub-lists to the SCP devices 804, 808, and 812. As such, the authenticated resource identity/location sub-list provisioning operations 1100 by the resource management system 304 may include generating an inventory for the BMS 802 that includes the location of the BMS 802 and the identity of each of the processing device 802a, the memory device(s) 802b, and other resource devices in the BMS 802, signing that inventory for the BMS 802 with a private key controlled by the resource management system 304, and transmitting that signed inventory for the BMS 802 to the SCP device 804.

Similarly, the authenticated resource identity/location sub-list provisioning operations 1100 by the resource management system 304 may include generating an inventory for the resource system 806 that includes the location of the resource system 806 and the identity of each the resource devices 806a-806b in the resource system 806, signing that inventory for the resource system 806 with the private key controlled by the resource management system 304, and transmitting that signed inventory for the resource system 806 to the SCP device 808. Similarly as well, the authenticated resource identity/location sub-list provisioning operations 1100 by the resource management system 304 may include generating an inventory for the resource system 810 that includes the location of the resource system 810 and the identify of each of the resource devices 810a-810b in the resource system 810, signing that inventory for the resource system 810 with the private key controlled by the resource management system 304, and transmitting that signed inventory for the resource system 810 to the SCP device 812.

As such, following the authenticated resource identity/location sub-list provisioning operations 1100 by the resource management system 304, the SCP device 804 may include a signed inventory for the BMS 802 that includes the location of the BMS 802 and the identity of each of the processing device 802a, the memory device(s) 802b, and other resource devices in the BMS 802, and the SCP device 804 may authenticate the location of the BMS 802 and the identity of each of the processing device 802a, the memory device(s) 802b, and other resource devices in the BMS 802 using a public key that corresponds to the private key controlled by the resource management system 304.

Similarly, following the authenticated resource identity/location sub-list provisioning operations 1100 by the resource management system 304, the SCP device 808 may include a signed inventory for the resource system 806 that includes the location of the resource system 806 and the identity of each of the resource devices 806a-806b in the resource system 806, and the SCP device 808 may authenticate the location of the resource system 806 and the identity of each of the resource devices 806a-806b in the resource system 806 using a public key that corresponds to the private key controlled by the resource management system 304.

Similarly as well, following the authenticated resource identity/location sub-list provisioning operations 1100 by the resource management system 304, the SCP device 812 may include a signed inventory for the resource system 810 that includes the location of the resource system 810 and the identity of each of the resource devices 810a-810b in the resource system 810, and the SCP device 812 may authenticate the location of the resource system 810 and the identity of each of the resource devices 810a-810b in the resource system 810 using a public key that corresponds to the private key controlled by the resource management system 304.

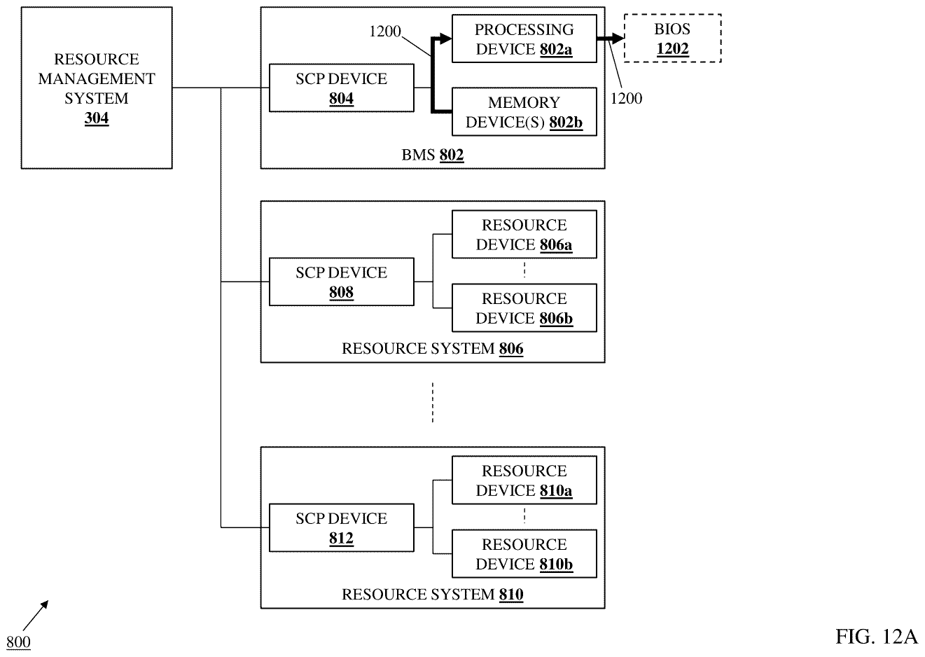

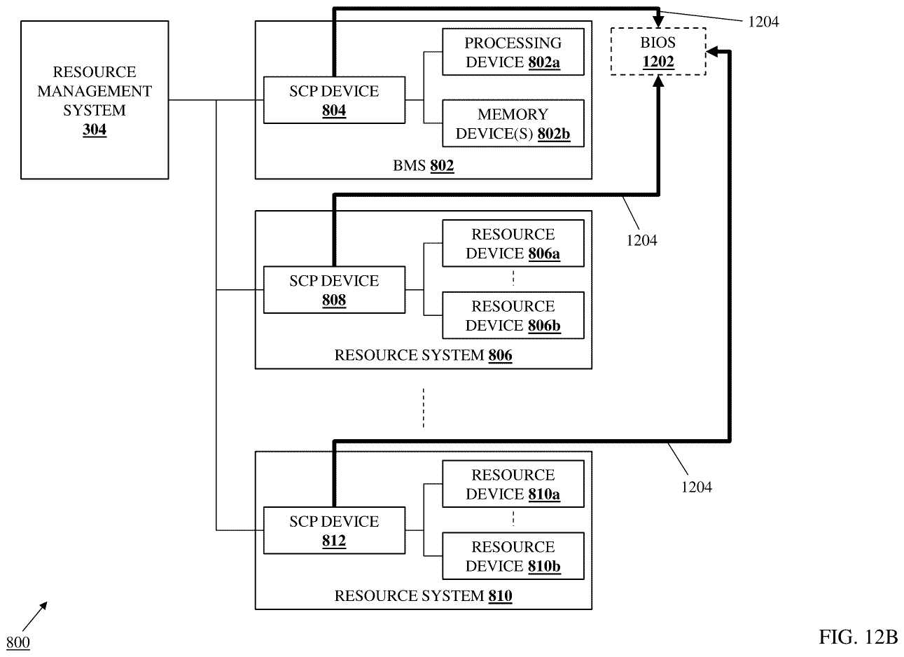

The method 700 then proceeds to block 706 where the management devices provide the authenticated resource identity/location sub-lists to a BMS to provide an authenticated resource identity/location list. With reference to FIG. 12A, the processing device 802a in the BMS 802 may perform BIOS provisioning operations 1200 that include executing instructions included on the memory device(s) 802b (e.g., a BIOS Serial Peripheral Interface (SPI) flash device) to provide a BIOS 1202. As will be appreciated by one of skill in the art in possession of the present disclosure, the SCP device 804 may utilize a root of trust to validate the BIOS 1202. With reference to FIG. 12B, in an embodiment of block 706, each of the SCP devices 804, 808, and 812 may perform authenticated resource identity/location sub-list provisioning operations 1204 that include providing the authenticated resource identity/location sub-list it received from the resource management system 304 to the BIOS 1202, and while each of the SCP devices 804, 808, and 812 are illustrated as providing its authenticated resource identity/location sub-list directly to the BIOS 1202, one of skill in the art in possession of the present disclosure will appreciate how the SCP devices 808 and 812 may provide their authenticated resource identity/location sub-lists to the BIOS 1202 via the SCP device 804 and the processing device 802a, while the SCP device 804 may provide its authenticated resource identity/location sub-list to the BIOS 1202 via the processing device 802a.

Thus, following the authenticated resource identity/location sub-list provisioning operations 1204, the BIOS 1202 may include an authenticated resource identity/location list that is made up of each of the authenticated resource identity/location sub-lists received from the SCP device 804, 808, and 812, and that includes the locations of each of the BMS 802, the resource system 806, and the resource system 810, as well as the identities of the processing device 802a, the memory device(s) 802b, other resource devices in the BMS 802, the resource devices 806a-806b, and the resource devices 810a-810b. Furthermore, one of skill in the art in possession of the present disclosure will recognize how the BIOS 1202 may authenticate the locations of the BMS 802 and the resource systems 806 and 810, as well as the identity of each of the processing device 802a, the memory device(s) 802b, other resource devices in the BMS 802, the resource devices 806a-806b, and the resource devices 810a-810b using a public key that corresponds to the private key controlled by the resource management system 304.

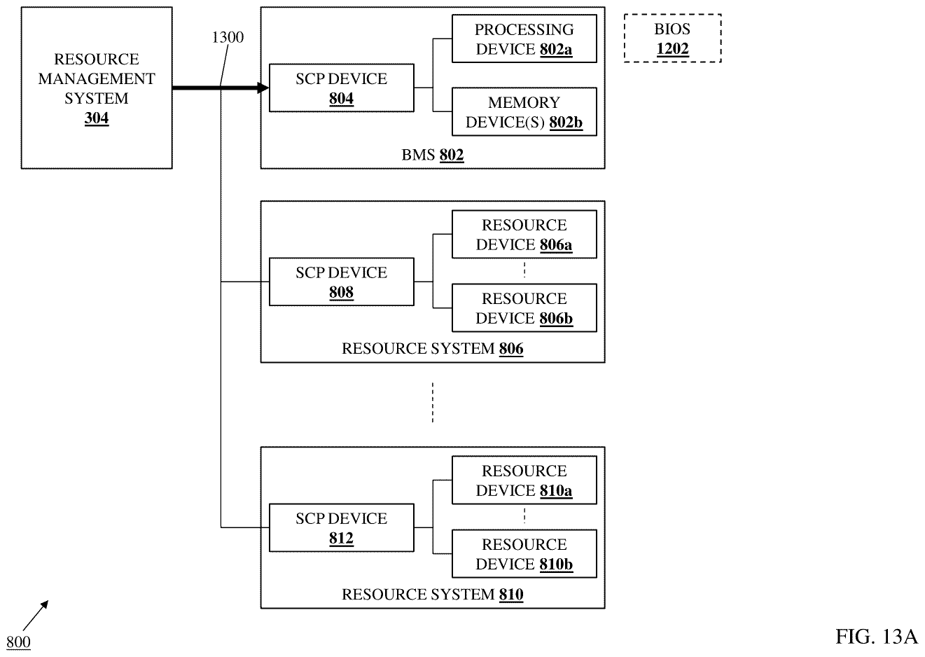

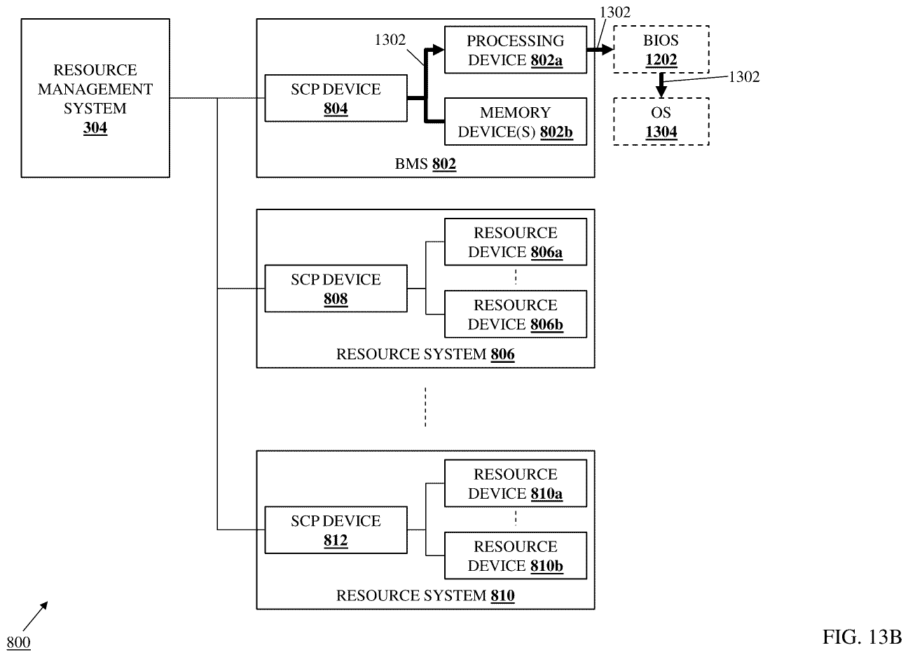

The method 700 then proceeds to block 708 where the resource management system instructs the BMS to provide an operating system. With reference to FIG. 13A, in an embodiment of block 708, the resource management system 304 may perform operating system provisioning instruction operations 1300 that include providing an instruction to the SCP device 804 to provide an operating system. For example, the operating system provisioning instruction operations 1300 by the resource management system 304 may include generating a identity certificate for an operating system that includes a microvisor that will be used to provide an LCS using the BMS and resource device(s) included in the resource systems 806 and 810, and providing the SCP device 804 that identity certificate along with an operating system image and operating system provisioning instruction to provide an operating system using that operating system image.

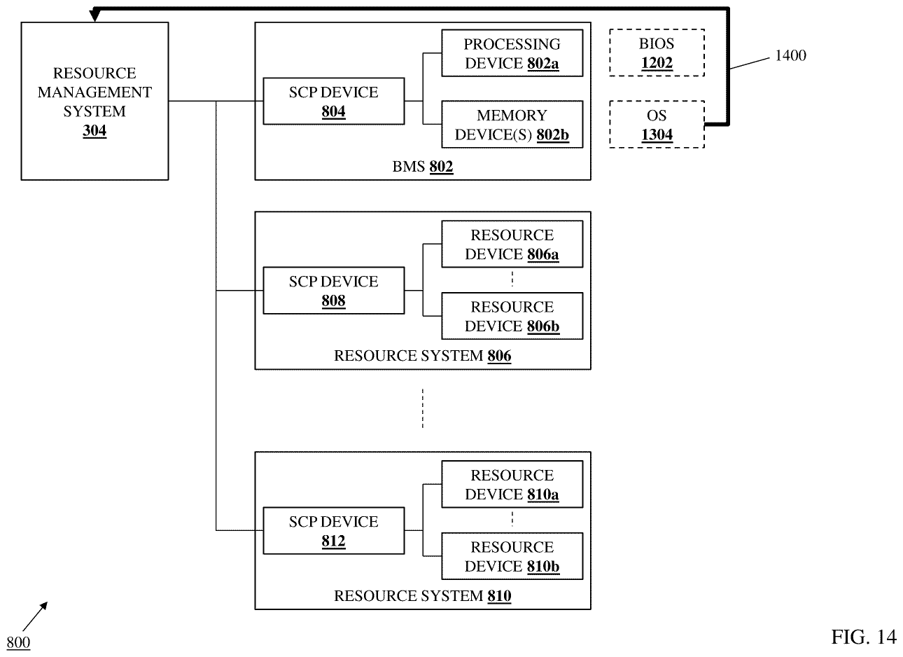

The method 700 then proceeds to block 710 where the BMS provides the operating system. With reference to FIG. 13B, at block 710 and in response to the SCP device 804 receiving the instruction to provide an operating system, the BMS 802 may perform operating system provisioning operations 1302 that include the processing device 802a retrieving the operating system provisioning instruction, the operating system image, and the identify certificate from the SCP device 804 and using the operating system image to cause the BIOS 1202 to provide an operating system 1304 that includes the microvisor discussed below that is configured to provide an LCS using the BMS 802 and resource device(s) included in the resource systems 806 and 810. With reference to FIG. 14, in an embodiment of block 712, the operating system 1304 may then perform operating system authentication operations 1400 that may include the operating system 1304 using the identity certificate received by the SCP device 804 from the resource management system 304 to authenticate with the resource management system 304 (e.g., using a public key included in the identity certificate).

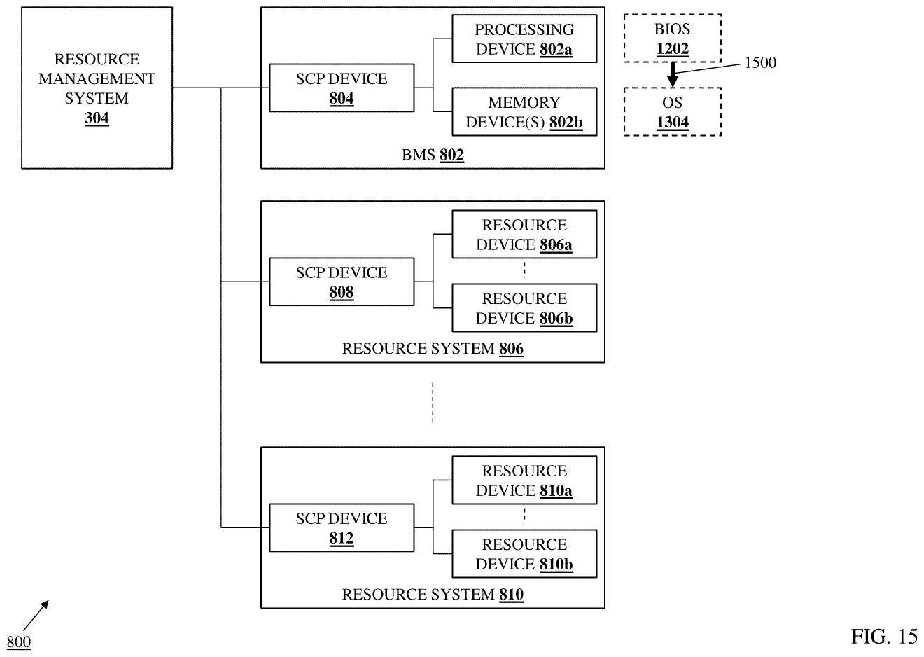

The method 700 then proceeds to block 712 where the BMS provides the authenticated resource identity/location list to the operating system. With reference to FIG. 15, in an embodiment of block 712, the BIOS 1202 may perform authenticated resource identity/location list provisioning operations 1500 that include the BIOS 1202 providing the authenticated resource identity/location list to the operating system 1304.

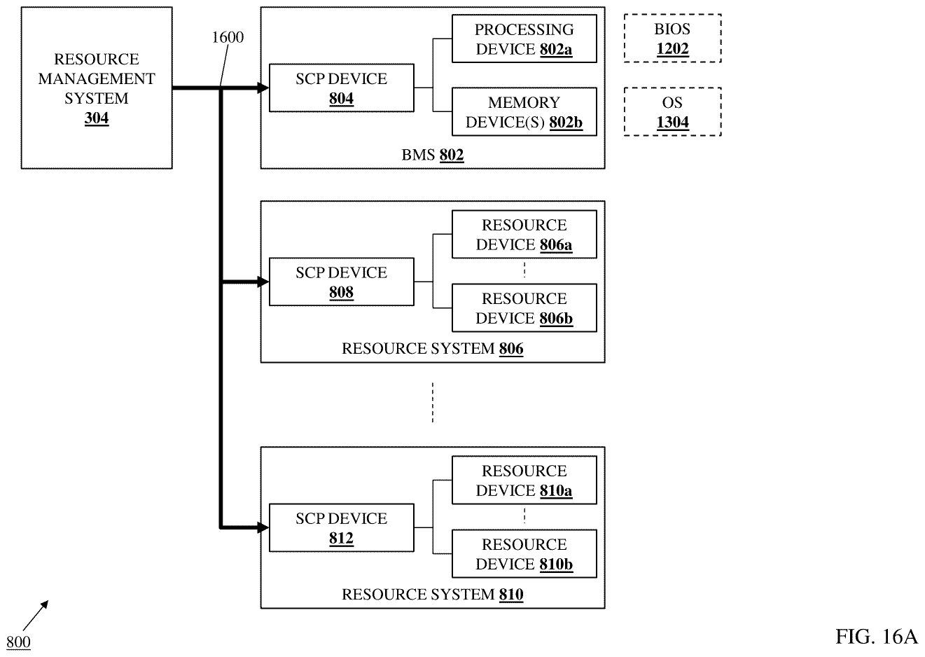

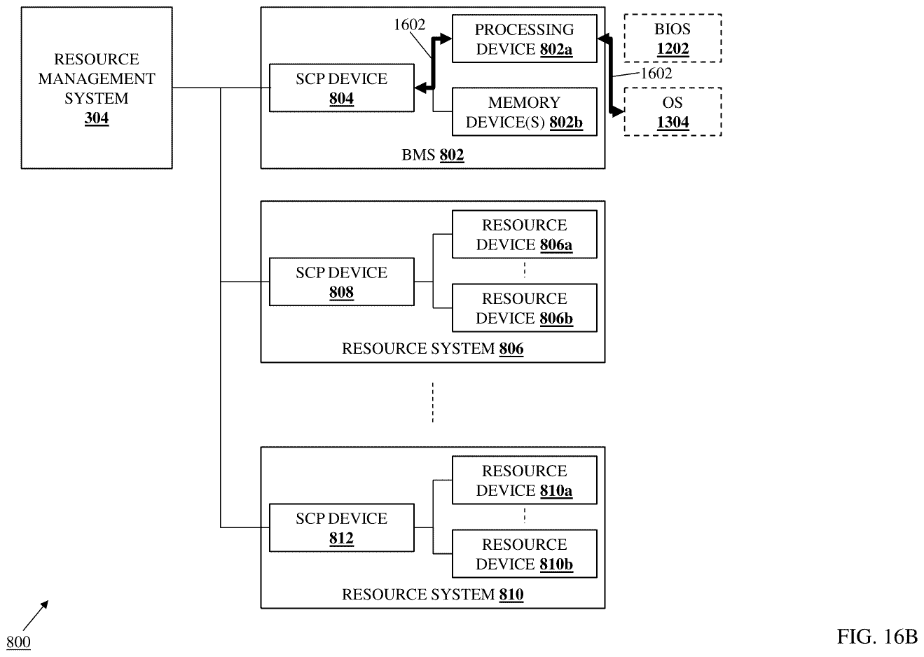

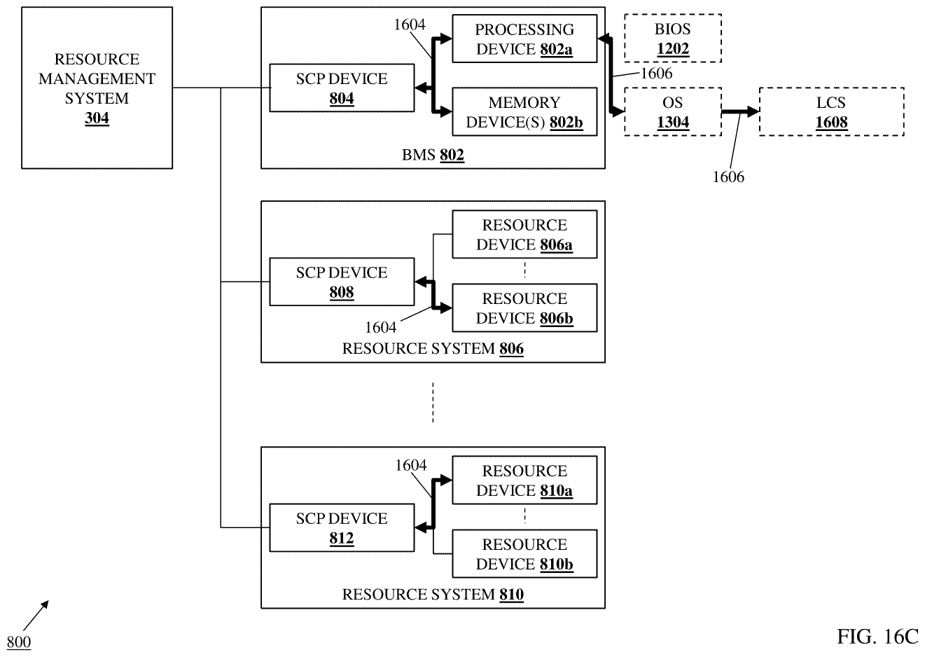

The method 700 then proceeds to block 714 where the resource management system provides an LCS provisioning instruction to the BMS. With reference to FIG. 16A, in an embodiment of block 714, the resource management system 1300 may perform LCS provisioning instruction operations 1600 that include transmitting LCS provisioning instructions to the SCP device 804 in the BMS 802, as well as to the SCP device 808 in the resource system 806 and the SCP device 812 in the resource system 810. For example, a user may provide a workload intent to the resource management system 304 as described above and, in response, the resource management system 304 may compose an LCS that satisfies that workload intent. In the examples below, the LCS is composed at block 714 using the processing device 802a and the memory device 802b in the BMS 802, the resource device 806b in the resource system 806, and the resource device 810a in the resource system 810, but one of skill in the art in possession of the present disclosure will appreciate how LCSs may be composed using any of a variety of resource devices that satisfy a workload intent while remaining within the scope of the present disclosure as well.

In an embodiment, as part of the composing of the LCS, the resource management system 304 may generate an LCS resource inventory for the LCS that identifies the processing device 802a and the memory device 802b in the BMS 802, the resource device 806b in the resource system 806, and the resource device 810a in the resource system 810, and may sign that LCS resource inventory with the private key that is controlled by the resource management system 304. As such, at block 714, the SCP device 804 may receive LCS provisioning instructions to provide the LCS using the processing device 802a and the memory device 802b in the BMS 802, the resource device 806b in the resource system 806, and the resource device 810a in the resource system 810, along with the signed LCS resource inventory. Furthermore, the SCP device 804 may receive LCS provisioning instructions to enable use of the resource device 806b in the resource system 806 by the LCS, and the SCP device 804 may receive LCS provisioning instructions to enable use of the resource device 810a in the resource system 810 by the LCS.

The method 700 then proceeds to block 716 where the BMS and the operating system validate the LCS provisioning instruction and confirm LCS resources for the LCS are on the authenticated resource identity/location list. With reference to FIG. 16B, in an embodiment of block 716, the SCP device 804 and the operating system 1304 may perform LCS validation/authentication operations 1602 that include the SCP device 804 providing the LCS provisioning instruction and the signed LCS resource inventory to the operating system 1304, and then each of the SCP device 804 and the operating system 1304 validating the signature in the signed LCS resource inventory using the public key that corresponds to the private key controlled by the resource management system 304, and confirming that the LCS resource (e.g., the processing device 802a and the memory device 802b in the BMS 802, the resource device 806b in the resource system 806, and the resource device 810a in the resource system 810) identified in the signed LCS resource inventory are each included in the authenticated resource identity/location list. While not illustrated or described in detail, one of skill in the art in possession of the present disclosure will appreciate how a failure to either validate the signature in the signed LCS inventory, or confirm that each of the LCS resources identified in the LCS resource inventory are included in the authenticated resource identity/location list, will prevent the provisioning of the LCS as described below.

The method 700 then proceeds to block 718 where the operating system provides the LCS with access to the authenticated resource identity/location list. With reference to FIG. 16C, in an embodiment of block 718 and in response to the SCP device 804 and the operating system 1304 validating the signature in the signed LCS inventory and confirming that each of the LCS resources identified in the LCS resource inventory are included in the authenticated resource identity/location list, the SCP devices 804, 808, and 810 may perform LCS resource configuration operations to configure the processing device 802a, the memory device(s) 802b, the resource device 806b, and the resource device 810a to provide the LCS, and the operating system 1304 may perform LCS provisioning operations 1606 that include providing an LCS 1608 using the processing device 802a, the memory device(s) 802b, the resource device 806b, and the resource device 810a.

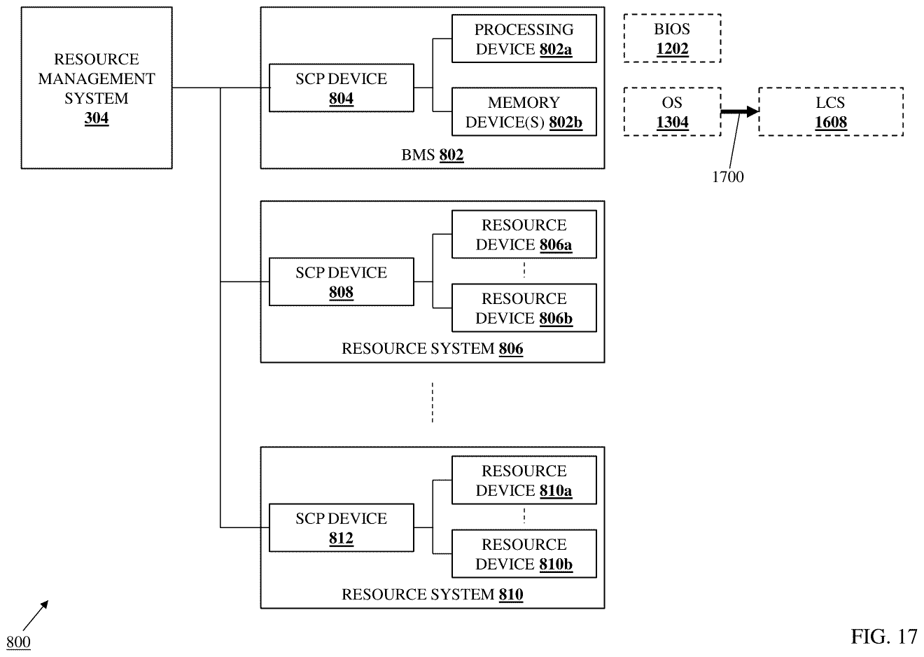

With reference to FIG. 17, the operating system 1304 may then perform authenticated resource identity/location list provisioning operations 1700 that include providing the authenticated resource identity/location list to the LCS 1608, which may include making the authenticated resource identity/location list (which may be stored in the memory device(s) 802b) accessible to the LCS 1608 using any techniques that would be apparent to one of skill in the art in possession of the present disclosure.

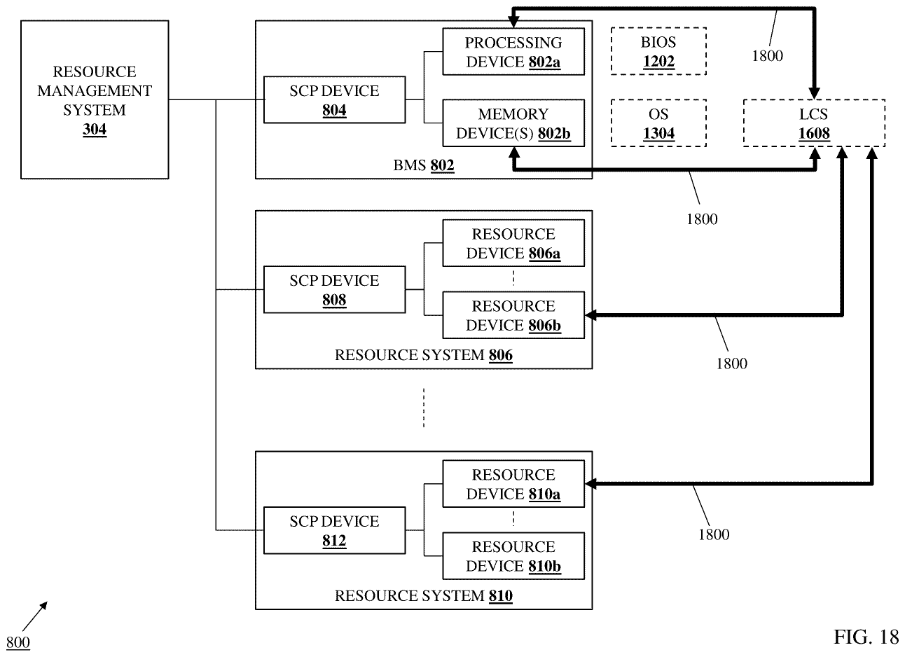

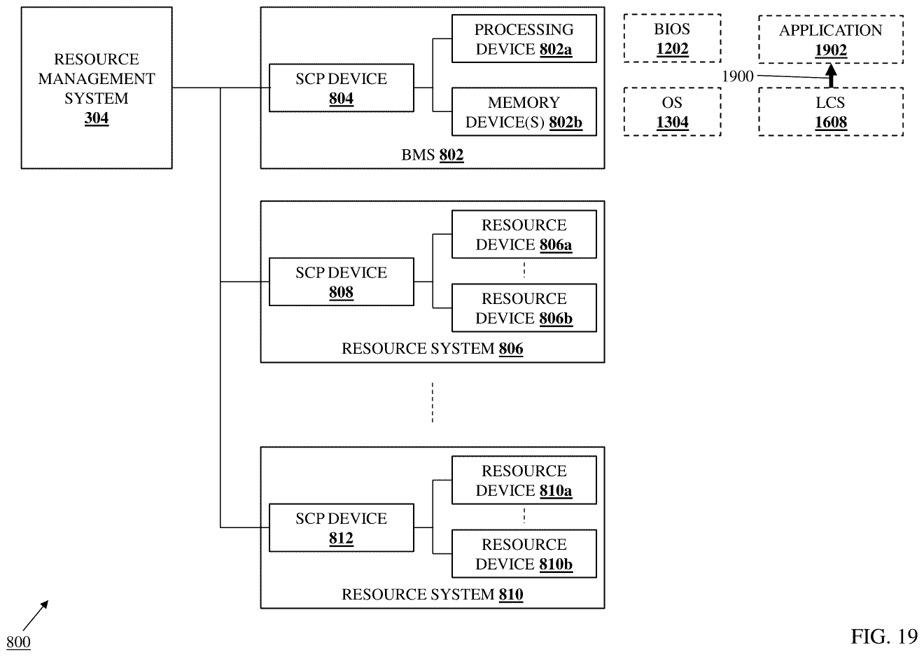

The method 700 then proceeds to block 720 where the LCS validates the LCS resources using the authenticated resource identity/location list. With reference to FIG. 18, in an embodiment of block 720, the LCS 1608 may perform LCS resource validation operations 1800 that include validating its LCS resources provided by the processing device 802a, the memory device(s) 802b, the resource device 806b, and the resource device 810b by confirming that the processing device 802a, the memory device(s) 802b, the resource device 806b, and the resource device 810b are included on the authenticated resource identity/location list. As such, the provisioning of the LCS 1608 may be bidirectionally authenticated and validated by both the resource management system 304 and the LCS 1608. As will be appreciated by one of skill in the art in possession of the present disclosure, following the validation of the LCS resources, the LCS 1608 may utilizes those LCS resources to satisfy the workload intent discussed above. For example, with reference to FIG. 19, the LCS 1608 may perform application provisioning operations 1900 that may include providing an application 1902 that is configured to satisfy the workload intent described above.

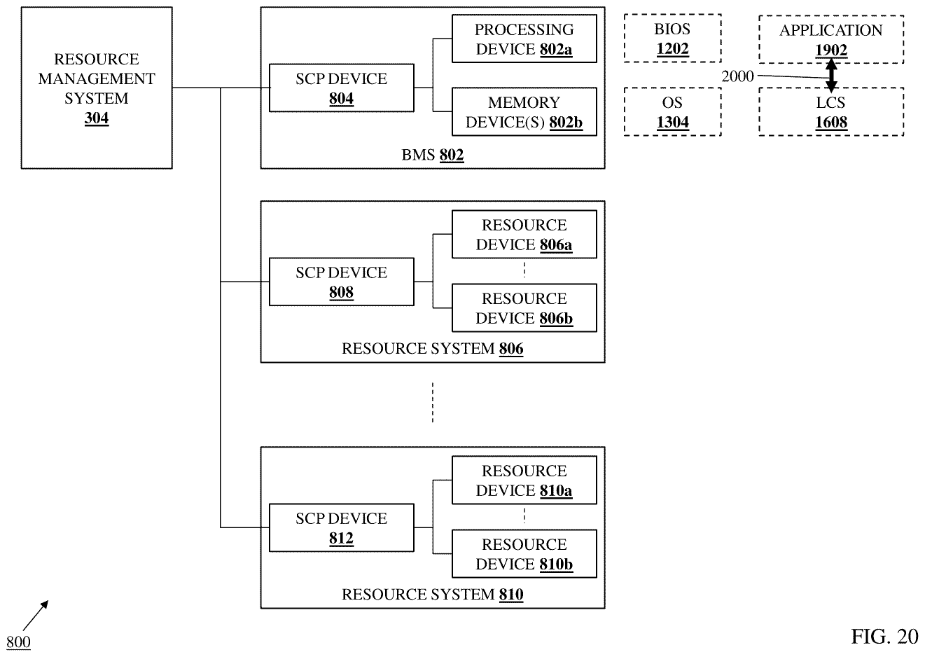

The method 700 then proceeds to block 722 where the LCS verifies authorized locations of the LCS resources to at least one application using the authenticated resource identity/location list. With reference to FIG. 20, in an embodiment of block 722, the application 1902 and the LCS 1608 may perform authorized location verification operations 2000 that include the LCS providing the locations of each of the LCS resources (e.g., the locations of the BMS 802 that includes the processing device 802a and the memory device(s) 802b, the resource system 806 that includes the resource device 806b, and the resource system 810 that includes the resource device 810b) in the authenticated resource identity/location list to the application 1902 such that the application 1902 may verify that those locations are authorized locations. For example, a user of the LCS 1608 may require that LCS 1608 be provided using resource devices that are located in the United States, and at block 722 the application 1902 provided by the LCS 1608 may verify that the processing device 802a, the memory device(s) 802b, the resource device 806b, and the resource device 810b are located in the United States.

As will be appreciated by one of skill in the art in possession of the present disclosure, the resource management system 304 may also operate to validate the LCS 1608 by validating its LCS resources using the authenticated resource identity/location list similarly as described above at block 720, and verifying authorized locations of those LCS resources using the authenticated resource identity/location list similarly as described above at block 722, thus allowing the resource management system 304 to provide LCS validation to applications and/or workloads that will be run using the LCS 1608. Furthermore, one of skill in the art in possession of the present disclosure will recognize how multiple resource management systems used to provide an LCS may validate subsets of its LCS resources and authenticate the locations of those subsets of LCS resources in a similar manner in order to provide the LCS validation to applications and/or workloads that will be run using the LCS 1608. As such, multiple different resource management systems may be used to provide an LCS with LCS resources in different valid locations (e.g., an LCS may be provided with LCS resources in a US East location, a US Central location, and/or a US West location, but not LCS resources in a US Hawaii location or an EU Central location).

As will be appreciated by one of skill in the art in possession of the present disclosure, the LCS resource authorized location verification system of the present disclosure may operate similarly as described above when migrating the LCS 1608 to a different BMS, with the identity of the resource devices in that BMS and the location of that BMS authenticated and made available to that LCS similarly as described above. As will be appreciated by one of skill in the art in possession of the present disclosure, the location context for an LCS may be abstracted from its LCS resources to provide a transferrable identity for the LCS that allows for its migration to different resource topologies if needed. For example, such an LCS may be securely transferred between resource management systems that are configured to validate the “new” locations of “new” LCS resources, perform the migration of the LCS to those “new” LCS resources, and revoke the “old” LCS resources at the “old” locations.

Similarly, resource management systems may be configured to generate and provide updates to the authenticated resource identity/location list that provide an updated location of at least one of the BMS and the plurality of resource devices used to provide an LCS, and that invalidate a previous location of the at least one of the BMS and the plurality of resource devices that provide the LCS. As such, resource management systems may provide for the migration of LCSs to new LCS resources (or even different resource management systems), and the LCS may use the updated authenticated resource identity/location list to revoke its trust of previous LCS resources in previous locations and authenticate new LCS resources in new locations substantially as described above. In some embodiments, a record for the resource management system(s) and the LCS may be created that identifies the pre-migrated LCS and that may be used to identify failed/recovered LCS resources, any deployment of that pre-migrated LCS on LCS resources, or the use of that pre-migrated LCS to subvert infrastructure by a malicious actor. In other words, LCSs may be migrated via updates to the authenticated resource identity/location list (an invalidations of previous LCS resources and LCS resource locations).

Thus, systems and methods have been described that provide for verification that LCS resources being used by an LCS are provided in an authorized location. For example, the LCS resource authorized location verification system of the present disclosure may include resource devices and a resource management system coupled to a BMS. The BMS receives an authenticated resource identity/location list authenticating the identity and location of the BMS and the resource devices. The BMS then provides an operating system with access to the authenticated resource identity/location list, and receives a request to provide an LCS using LCS resources including the BMS and the resource device(s). The BMS and operating system each validate the LCS provisioning instruction and confirm the LCS resources on the authenticated resource identity/location list and, in response, use the operating system to provide the LCS with access to the authenticated resource identity/location list. The LCS then confirms the LCS resources are on the authenticated resource identity/location list, provides an application, and uses the authenticated resource identity/location list to verify the authorized location of the LCS resources to the application. As such, a user of an application may ensure that their application is being provided by an LCS that uses LCS resources in locations they authorize. Furthermore, resource management systems and LCSs may bidirectionally validate the runtime trustworthiness of LCSs.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A Logically Composed System (LCS) resource authorized location verification system, comprising:
a plurality of resource devices;
a resource management system; and
a Bare Metal Server (BMS) coupled to the plurality of resource devices and the resource management system, wherein the BMS is configured to:
receive an authenticated resource identity/location list that was generated by the resource management system and that authenticates a respective identity and location of each of the BMS and the plurality of resource devices;
provide, in response to an operating system instruction from the resource management system, an operating system that has access to the authenticated resource identity/location list;
receive, from the resource management system, an LCS provisioning instruction to provide an LCS using LCS resources that include the BMS and a subset of the plurality of resource devices, wherein the BMS and the operating system are each configured to:
validate the LCS provisioning instruction and confirm the LCS resources are included on the authenticated resource identity/location list and, in response, use the operating system to provide the LCS that has access to the authenticated resource identity/location list and that is configured to:
confirm the LCS resources are included on the authenticated resource identity/location list;
provide an application; and
verify, to the application using the authenticated resource identity/location list, the authorized location of each of the LCS resources.

2. The system of claim 1, wherein the resource management system is configured to:
authenticate the respective identity of the BMS and each of the plurality of resource devices;
identify a respective location of the BMS and each of the plurality of resource devices;
generate the authenticated resource identity/location list; and
provide the authenticated resource identity/location list to the BMS.

3. The system of claim 1, wherein the operating system instruction includes an identity certificate for the operating system, and wherein the operating system is configured to authenticate with the resource management system using the identity certificate.

4. The system of claim 1, wherein the LCS provisioning instruction includes a list of the LCS resources that is signed by the resource management system, and wherein the validating the LCS provisioning instruction includes validating a signature used to sign the list of the LCS resources.

5. The system of claim 1, wherein the BMS receiving the authenticated resource identity/location list that was generated by the resource management system and that authenticates the respective identity and location of each of the BMS and the plurality of resource devices includes receiving a plurality of authenticated resource identity/location sub-lists from management devices that manage the BMS and the plurality of resource devices.

6. The system of claim 1, wherein the BMS includes a Basic Input Output System (BIOS) that is configured to receive the authenticated resource identity/location list and provide the authenticated resource identity/location list to the operating system.

7. The system of claim 1, wherein the BMS is configured to:
receive an update to authenticated resource identity/location list that was generated by the resource management system and that provides an updated location of at least one of the BMS and the plurality of resource devices and invalidates a previous location of the at least one of the BMS and the plurality of resource devices.

8. A Bare Metal Server (BMS), comprising:
a processing system; and
a memory system that is coupled to the processing system and that includes instructions that, when executed by the processing system, cause the processing system to provide a BMS engine that is configured to:
receive an authenticated resource identity/location list that was generated by a resource management system and that authenticates a respective identity and location of each of a Bare Metal Server (BMS) that includes the processing system, and a plurality of resource devices;
provide, in response to an operating system instruction from the resource management system, an operating system that has access to the authenticated resource identity/location list;
receive, from the resource management system, an LCS provisioning instruction to provide an LCS using LCS resources that include the BMS and a subset of the plurality of resource devices, wherein the BMS engine and the operating system are each configured to:
validate the LCS provisioning instruction and confirm the LCS resources are included on the authenticated resource identity/location list and, in response, use the operating system to provide the LCS that has access to the authenticated resource identity/location list and that is configured to:
confirm the LCS resources are included on the authenticated resource identity/location list;
provide an application; and
verify, to the application using the authenticated resource identity/location list, the authorized location of each of the LCS resources.

9. The BMS of claim 8, wherein the operating system instruction includes an identity certificate for the operating system, and wherein the operating system is configured to authenticate with the resource management system using the identity certificate.

10. The BMS of claim 8, wherein the LCS provisioning instruction includes a list of the LCS resources that is signed by the resource management system, and wherein the validating the LCS provisioning instruction includes validating a signature used to sign the list of the LCS resources.

11. The BMS of claim 8, wherein the BMS engine receiving the authenticated resource identity/location list that was generated by the resource management system and that authenticates the respective identity and location of each of the BMS and the plurality of resource devices includes receiving a plurality of authenticated resource identity/location sub-lists from management devices that manage the BMS and the plurality of resource devices.

12. The BMS of claim 8, wherein the BMS engine includes a Basic Input Output System (BIOS) that is configured to receive the authenticated resource identity/location list and provide the authenticated resource identity/location list to the operating system.

13. The IHS of claim 8, wherein the BMS engine is configured to:
receive an update to authenticated resource identity/location list that was generated by the resource management system and that provides an updated location of at least one of the BMS and the plurality of resource devices and invalidates a previous location of the at least one of the BMS and the plurality of resource devices.

14. A method for verifying that resources used for an Logically Composed System (LCS) are provided in an authorized location, comprising:
receiving, by a Bare Metal Server (BMS), an authenticated resource identity/location list that was generated by a resource management system and that authenticates a respective identity and location of each of the BMS and a plurality of resource devices;
providing, by the BMS in response to an operating system instruction from the resource management system, an operating system that has access to the authenticated resource identity/location list;
receiving, by the BMS from the resource management system, an LCS provisioning instruction to provide an LCS using LCS resources that include the BMS and a subset of the plurality of resource devices;
validating, by the BMS and the operating system, the LCS provisioning instruction and confirm the LCS resources are included on the authenticated resource identity/location list and, in response, using the operating system to provide the LCS that has access to the authenticated resource identity/location list;
confirming, by the LCS, the LCS resources are included on the authenticated resource identity/location list;
providing, by the LCS, an application; and
verifying, by the LCS to the application using the authenticated resource identity/location list, the authorized location of each of the LCS resources.

15. The method of claim 14, further comprising:
authenticating, by the resource management system, the respective identity of the BMS and each of the plurality of resource devices;
identifying, by the resource management system, a respective location of the BMS and each of the plurality of resource devices;
generating, by the resource management system, the authenticated resource identity/location list; and
providing, by the resource management system, the authenticated resource identity/location list to the BMS.

16. The method of claim 14, wherein the operating system instruction includes an identity certificate for the operating system, and wherein the operating system authenticates with the resource management system using the identity certificate.

17. The method of claim 14, wherein the LCS provisioning instruction includes a list of the LCS resources that is signed by the resource management system, and wherein the validating the LCS provisioning instruction includes validating a signature used to sign the list of the LCS resources.

18. The method of claim 14, wherein the BMS receiving the authenticated resource identity/location list that was generated by the resource management system and that authenticates the respective identity and location of each of the BMS and the plurality of resource devices includes receiving a plurality of authenticated resource identity/location sub-lists from management devices that manage the BMS and the plurality of resource devices.

19. The method of claim 14, wherein the BMS includes a Basic Input Output System (BIOS) that receives the authenticated resource identity/location list and provides the authenticated resource identity/location list to the operating system.

20. The method of claim 14, further comprising:
receiving, by the BMS, an update to the authenticated resource identity/location list that was generated by the resource management system and that provides an updated location of at least one of the BMS and the plurality of resource devices and invalidates a previous location of the at least one of the BMS and the plurality of resource devices.
